(19) United States
(12) Patent Application Publication
(10) Pub. No.: US 2025/0324320 A1
(43) Pub. Date: Oct. 16, 2025

(54) UE, RADIO NETWORK NODE, AND METHODS PERFORMED IN A WIRELESS COMMUNICATION NETWORK

(71) Applicant: Telefonaktiebolaget LM Ericsson (publ), Stockholm (SE)

(72) Inventors: Mårten ERICSON, Gammelstad (SE); Patrik RUGELAND, Bromma (SE)

(21) Appl. No.: 18/712,426

(22) PCT Filed: Nov. 26, 2021
(86) PCT No.: PCT/SE2021/051179

§ 371 Date: May 22, 2024

(51) Int. Cl. H04W 28/02; H04L 69/22

(52) U.S. Cl. CPC H04W 28/0278; H04L 69/22

(57) ABSTRACT

Embodiments herein disclose, for example, a method performed by a UE for handling data transmitted over a split bearer between a first radio network node and the UE, and between a second radio network node and the UE in a wireless communication network. The UE buffers one or more packets from the first radio network node and the second radio network node received over the split bearer in a reordering buffer; and transmits one or more indications to one of the radio network nodes, wherein the one or more indications indicate a status of the reordering buffer.

### TECHNICAL FIELD

Embodiments herein relate to a user equipment (UE), a radio network node and methods performed therein regarding wireless communication. Furthermore, a computer program product and a computer-readable storage medium are also provided herein. Especially, embodiments herein relate to handling or enabling communication, e.g., enabling efficient transmission, in a wireless communication network.

### BACKGROUND

In a typical wireless communication network, user equipments (UE), also known as wireless communication devices, mobile stations, stations (STA) and/or wireless devices, communicate via a Radio access Network (RAN) to one or more core networks (CN). The RAN covers a geographical area which is divided into service areas or cell areas, with each service area or cell area being served by a radio network node such as an access node e.g. a Wi-Fi access point or a radio base station (RBS), which in some radio access technologies (RAT) may also be called, for example, a NodeB, an evolved NodeB (eNodeB) and a gNodeB (gNB). The service area or cell area is a geographical area where radio coverage is provided by the radio network node. The radio network node operates on radio frequencies to communicate over an air interface with the wireless devices within range of the access node. The radio network node communicates over a downlink (DL) to the wireless device and the wireless device communicates over an uplink (UL) to the access node.

A Universal Mobile Telecommunications System (UMTS) is a third generation telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for communication with user equipments. In a forum known as the Third Generation Partnership Project (3GPP), telecommunications suppliers propose and agree upon standards for present and future generation networks and UTRAN specifically, and investigate enhanced data rate and radio capacity. In some RANs, e.g., as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. The RNCs are typically connected to one or more core networks.

Specifications for the Evolved Packet System (EPS) have been completed within the 3^{rd} Generation Partnership Project (3GPP) and this work continues in the coming 3GPP releases (Rel). The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the Radio Access Network (RAN) of an EPS has an essentially “flat” architecture comprising radio network nodes connected directly to one or more core networks.

With the emerging 5G technologies also known as new radio (NR), the use of, e.g., very many transmit- and receive-antenna elements makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions.

Beamforming allows the signal to be stronger for an individual connection. On the transmit-side this may be achieved by a concentration of the transmitted power in the desired direction(s), and on the receive-side this may be achieved by an increased receiver sensitivity in the desired direction(s). This beamforming enhances throughput and coverage of the connection. It also allows reducing the interference from unwanted signals, thereby enabling several simultaneous transmissions over multiple individual connections using the same resources in the time-frequency grid, so-called multi-user Multiple Input Multiple Output (MIMO).

In TS 36.300 v16.3.0, dual connectivity (DC) was introduced in Rel-12 and is defined for intra-E-UTRA Dual Connectivity as depicted in FIGS. 1a-1b, that highlight the control (C)-plane, FIG. 1a, and user (U)-Plane connectivity, FIG. 1b. Both Master eNodeB (MeNB) and Secondary eNodeB (SeNB) are E-UTRA nodes, with an EPC core network (CN) entity.

In TS 37.340 v16.3.0, dual connectivity is further defined for Multi-Radio Dual Connectivity (MR-DC), which was introduced in Rel-15, which implies in having a UE configured with two different nodes-one providing E-UTRA access and the other one providing NR access. The CN entity associated to MR-DC can be either EPC or 5GC, which divides MR-DC cases in:
E-UTRA-NR Dual Connectivity (EN-DC), comprised in EPS, as a MN E-UTRA eNB and an NR en-gNB as a SN, en-gNB refers to a NR gNB that is operating in a non standalone mode operating as the SN;
NG-RAN E-UTRA-NR Dual Connectivity (NGEN-DC), comprised in 5GS, as a MN ng-eNB (ng-eNB refers to E-UTRA eNB connected to 5GC) and an NR gNB as the SN;
NR-E-UTRA Dual Connectivity (NE-DC), comprised in 5GS, as a MN NR gNB and an E-UTRA ng-eNB as the SN;
NR-NR Dual Connectivity (NR-DC), comprised in 5Gs, as NR gNBs as both the MN and the SN.
   A gNB or ng-eNB are collectively referred to as NG-RAN nodes.
   Control plane and User plane connectivity for EN-DC case is depicted in FIGS. 1a-1b, MR-DC case associated with 5GC is depicted in FIGS. 2a-2b.

### Radio Bearer Configuration in Dual Connectivity.

In MR-DC, a data radio bearer (DRB) can be terminated in either the MN or the SN and be transmitted via either the master cell group (MCG) at the MN and/or via the secondary cell group (SCG) at the SN as depicted in FIG. 3 and FIG. 4 for EN-DC and other MR-DC options respectively. Namely there are MN and SN terminated MCG and SCG bearers as well as MN and SN terminated split bearers, which are transmitted via both the MCG and SCG. For signaling radio bearers (SRB) only MN terminated MCG bearers (SRB1, SRB2, SRB4), MN terminated split bearers, e.g., SRB1 and SRB2, and SN terminated SCG bearer (SRB3) are allowed.

### Packet Data Convergence Protocol (PDCP).

The decision to add a secondary node and create a dual connectivity (EN-DC, LTE DC, NGEN-DC, NE-DC or NR-DC) connection to the UE is (typically) based on the UE reports measurement results. The network can configure the UE with different measurements, e.g., the A4 event when a neighbor cell becomes better than a threshold or the A3 event when a neighbor becomes x dB better than serving node. The network then configures the UE to add the secondary node. If a split DRB is used the MN then splits the PDCP packets it receives from the user plane function (UPF) between the MN and SN. In the UE the PDCP packets are put into a buffer. This buffer orders the packet so that the upper layer, such as application layers, receives the PDCP packets in order. Therefore, the buffer is called the reordering buffer.

### UE Reordering Buffer Size.

According to TS 38.306 v16.2.0, the UE is required to provide a total layer 2 buffer size for reordering. The total layer 2 buffer size is defined as the sum of the number of bytes that the UE is capable of storing in the radio link control (RLC) transmission windows and RLC reception and reordering windows and also in PDCP reordering windows for all radio bearers.

The required total layer 2 buffer size in MR-DC and NR-DC is the maximum value of the calculated values based on the following equations:

MaxULDataRate_MN*RLCRTT_MN+MaxULDataRate_SN*RLCRTT_SN+MaxDLDataRate_SN*RLCRTT_SN+MaxDLDataRate_MN*(RLCRTT_SN+X2/Xn delay+Queuing in SN)

MaxULDataRate_MN*RLCRTT_MN+MaxULDataRate_SN*RLCRTT_SN+MaxDLDataRate_MN*RLCRTT_MN+MaxDLDataRate_SN*(RLCRTT_MN+X2/Xn delay+Queuing in MN)

Otherwise it is calculated by:

MaxDLDataRate*RLC RTT+MaxULDataRate*RLC RTT.

NOTE: Additional layer 2 (L2) buffer required for preprocessing of data is not taken into account in above formula.

The required total layer 2 buffer size is determined as the maximum total layer 2 buffer size of all the calculated ones for each band combination and the applicable Feature Set combination in the supported MR-DC or NR band combinations. The RLC round trip time (RTT) for NR cell group corresponds to the smallest subcarrier spacing (SCS) numerology supported in the band combination and the applicable Feature Set combination.

An example of realistic (maximum) delays is given below.
X2/Xn delay+Queuing in SN=25 ms if SCG is NR, and 55 ms if SCG is EUTRA
X2/Xn delay+Queuing in MN=25 ms if MCG is NR, and 55 ms if MCG is EUTRA
RLC RTT for EUTRA cell group=75 ms
RLC RTT for NR cell group is defined in Table 4.1.4-1

TABLE 4.1.4-1
RLC RTT for NR cell group per SCS

| | |
|---|---|
| SCS (KHz) | RLC RTT (ms) |

| | | |
|---|---|---|
| 15 | KHz | 50 |
| 30 | KHz | 40 |
| 60 | KHz | 30 |
| 120 | KHz | 20 |

Calculating the maximum throughput for NR using a 400 MHz bandwidth (BW), 120 KHz SCS, 8 carriers, 8 MIMO layers and 256 Quadrature Amplitude Modulation (QAM), a maximum (peak) bit-rate of 275 Gbps per path is obtained. Inserting this into the above buffer size equations and using 25 ms as delay for NR, a L2 buffer of 18 Gbit (2 GB) is obtained.

From WO 2017/077433, it is disclosed that in data networks, packets of a data stream may reach their destination via multiple paths. A routing function at a “splitting point” has to decide which packets shall take which path. A flow-control algorithm may be provided which has the aim to ensure that a receiver at the destination can deliver “reordered data” as fast as possible to an application using the data.

A multiple receiver (RX) transmitter (TX) UE in RRC_CONNECTED mode is configured to utilize radio resources provided by two distinct schedulers, located in two e/gNBs connected via a non-ideal backhaul over the Xn/X2 interface.

For the transport of user plane data from the User Plane Function (UPF) or the security gateway (S-GW) to the UE, so-called “split bearers” may be used. Split bearers provide two paths for downlink user plane data.

The user plane data may either be sent from the UPF/S-GW via a MN/MeNB to the UE, or they can be sent from the S-GW via the MeNB to a SN/SeNB which finally sends them to the UE. For a “split bearer” the MN for U-plane may be connected to the SN via N5/S1-U and in addition, the MN is interconnected to a SN via Xn-U/X2-U.

The routing function in the PDCP layer of the MN/MeNB decides whether a PDCP layer protocol data unit (PDU) of a split bearer is sent directly over the local air interface to the UE or whether it is forwarded to the SN via X2-U. A PDCP layer reordering function in the UE receives PDUs from the MN and from the SN, reorders them and forwards them to the application running on the UE.

At least for LTE-internal split-bearer operation, the purpose of the X2-U Downlink data delivery status procedure is to provide feedback from the SN to the MN to allow the MN to control the downlink user data flow via the SN for the respective EUTRAN radio access bearer (E-RAB).

When the SN decides to trigger the feedback for Downlink Data Delivery procedure it shall report:
a) the highest PDCP PDU sequence number successfully delivered in sequence to the UE among those PDCP PDUs received from the MN;
b) the desired buffer size in bytes for the concerned radio bearer;
c) the minimum desired buffer size in bytes for the UE; and
d) the X2-U packets that were declared as being “lost” by the SN and have not yet been reported to the MN within the DL DATA DELIVERY STATUS frame.

The reporting format proposed in WO 2017/077433, while keeping overhead tolerable, would enable the eNB to determine failures of packets transmitted over Wi-Fi, the WLAN-branch throughput and the amount of data queued for the bearer in WLAN, allowing an efficient flow control when feedback from WLAN is not available. As e/gNB knows the sizes of the PDCP PDUs sent via WLAN, it can easily calculate the throughput over Wi-Fi air interface adding up the sizes of acknowledged packets and dividing it by the time elapsed from the last status report. The amount of data queued in WLAN for one bearer is easily calculated as the difference between the cumulated size of packets already sent over Wi-Fi and the cumulated size of acknowledged packets.

### PDCP Data and Status Report (TS 38.323)

The PDCP data PDU for data radio bearers (DRB) with 18 bits PDCP SN is depicted below. The FIG. 5 shows the format of the PDCP Data PDU with 18 bits PDCP SN. This format is applicable for unacknowledged Mode (UM) DRBs and acknowledged mode (AM) DRBs. Thus, FIG. 5 shows PDCP Data PDU format for DRBs with 18 bits PDCP SN

For acknowledgment mode (AM) DRBs configured by upper layers to send a PDCP status report in the uplink (statusReportRequired in TS 38.331 [3]), the receiving PDCP entity shall trigger a PDCP status report when:
upper layer requests a PDCP entity re-establishment;
upper layer requests a PDCP data recovery;
upper layer requests a uplink data switching;
upper layer reconfigures the PDCP entity to release DAPS and daps-SourceRelease is configured in TS 38.331 [3].

The status report is included in the PDCP Control PDU.

In section 6.2.3.1 of 38.323 v.16.0.0, the Control PDU for PDCP status report is explained.

FIG. 6 shows the format of the PDCP Control protocol data unit (PDU) carrying one PDCP status report. This format is applicable for UM DRBs and AM DRBs, including sidelink DRBs for unicast. FIG. 6 shows a PDCP Control PDU format for PDCP status report.

The “FMC” is the “First Missing COUNT” of a PDCP sequence number. This field indicates the COUNT value of the first missing PDCP SDU within the reordering window, i.e., RX_DELIV. A bitmap can also be used, where the bit position indicates the missing service data units (SDU).

### PDCP Status Report Over F1-U (TS 38.425 v16.2.0)

In case of split architecture with central unit and distributed units (CU-DU), the DU can acknowledges the successfully transmitted PDCP PDUs, using the Downlink Data Delivery Status over F1-U (TS 38.425 v16.2.0):

### DL Data Delivery Status (PDU Type 1)

This frame format is defined to transfer feedback to allow the receiving node, i.e., the node that hosts the NR PDCP entity, to control the downlink user data flow via the sending node, i.e., the corresponding node.

The following shows the respective DL DATA DELIVERY STATUS frame. The FIG. 7a shows an example of how a frame is structured when all optional information elements (IE), i.e., those whose presence is indicated by an associated flag, are present.

Absence of such an IE changes the position of all subsequent IEs on octet level.

The dual connectivity splitting function in PDCP tries to estimate the rate on each path based on flow control feedback, and may split traffic, accordingly, see FIG. 7b. These paths can have different and varying characteristics, e.g., link rate, congestion, latency. To handle the delays that may occur, the UE L2 re-ordering buffer size must be dimensioned for this, as calculated according to 38.306, based on a typical RTT delays for SN and MN paths.

However, the problem is that regardless if the buffer can handle the delays due to the varying characteristics of the paths, it still means that there will be delay until the packets can be delivered in-order to the upper layers. The main reason for this is that the MN PDCP flow-control does not have a fast and efficient feedback from the SN path. Due to the delays the flow-control feedback may be invalid. Current solution relies on that there is a feedback from DU to CU via the UL GPRS Tunnelling Protocol (GTP) header over F1-U, i.e. the feed-back between the radio network nodes.

If packets are sent down the wrong path this will increase the total delay further and can lead to packet losses due to limited reordering capabilities in the UE, as the UE is required to wait for the outstanding data packets before it can forward them to the higher layers.

FIG. 7b gives an example of the problem. The MN PDCP flow-control sends a PDU packet t₁ (time=1 or packet number=1) to the SN. At the same time the MN transmits several PDU packets t₂-t₁₀. The UE receives these packets and put them in the reordering buffer as it need to wait for the PDU t₁. If the reordering buffer size exceeds a maximum threshold the UE need to start drop PDCP SDU packets.

FIG. 7b shows an example of the flow control problem with a bad SN path. The MN PDCP flow-control sends a PDU at time t₁ to the SN. At the same time the MN transmits several PDU packets t₂-t₁₀.

WO 2017/077433 lets the UE send a report to the MN if a condition is triggered. The UE can then send the missing sequence numbers of the PDCP packets and the highest PDCP sequence number received so far may provide a flow-control in MN to react quicker to problems with a path. However, a problem is still that the MN reacts after a problem has been detected, thus this will still cause a delay of PDCP deliverable.

To summarize, the main problem is the slow flow-control feedback from the different transmission paths. It is hard for the PDCP entity to handle the fast variations of the MN and SN path and this may lead to that the UE, or the corresponding PDCP buffer in the MN, needs to buffer a lot of PDCP SDU that are waiting for the PDCP packets on the bad transmission path. Note that since the DRBs can be terminated in either the MN or the SN, the same issue arises, when it is the SN that should adjust the flow-control based on feedback from the MN.

### SUMMARY

An object of embodiments herein is to provide a mechanism that handles transmissions of data over a split bearer in an efficient manner.

According to an aspect, the object may be achieved by providing a method performed by a UE for handling data transmitted over a split bearer between a first radio network node and the UE, and between a second radio network node and the UE in a wireless communication network. The UE buffers one or more packets from the first radio network node and the second radio network node received over the split bearer in a reordering buffer. The UE further transmits one or more indications to one of the radio network nodes, wherein the one or more indications indicate a status of the reordering buffer.

According to another aspect, the object may be achieved by providing a method performed by a radio network node for handling transmission of data over a split bearer between a first radio network node and a UE, and between a second radio network node and the UE in a wireless communication network. The radio network node receives one or more indications from the UE, wherein the one or more indications indicate a status of a reordering buffer at the UE. The radio network node further performs a transmission of one or more packets over the split bearer based on the received one or more indications.

According to yet another aspect, the object may be achieved by providing a UE for handling data transmitted over a split bearer between a first radio network node and the UE, and between a second radio network node and the UE in a wireless communication network. The UE is configured to buffer one or more packets from the first radio network node and the second radio network node received over the split bearer in a reordering buffer. The UE is further configured to transmit one or more indications to one of the radio network nodes, wherein the one or more indications indicate a status of the reordering buffer.

According to still another aspect, the object may be achieved by providing a radio network node for handling transmission of data over a split bearer between a first radio network node and a UE, and between a second radio network node and the UE in a wireless communication network. The radio network node is configured to receive one or more indications from the UE, wherein the one or more indications indicate a status of a reordering buffer at the UE. The radio network node is further configured to perform a transmission of one or more packets over the split bearer based on the received one or more indications.

It is furthermore provided herein a computer program product comprising instructions, which, when executed on at least one processor, cause the at least one processor to carry out the methods above, as performed by the radio network node or UE, respectively. It is additionally provided herein a computer-readable storage medium, having stored thereon a computer program product comprising instructions which, when executed on at least one processor, cause the at least one processor to carry out the methods above, as performed by the UE or radio network node, respectively.

Embodiments herein allow a faster and more reliable way to update the network about the status of the reordering buffer in the UE. The one or more indications may be periodically sent via an RRC message, e.g., the UEAssistanceInformation. Since the radio network node is informed about the status of the reordering buffer, status, e.g., indicating throughout over respective transmission path, the radio network node may determine transmission strategy and thus transmissions of data over the split bearer may be handled in an efficient manner.

### BRIEF DESCRIPTION OF THE DRAWINGS

Embodiments will now be described in more detail in relation to the enclosed drawings, in which:

FIGS. 1a-1b show C-Plane and U-Plane connectivity of eNBs involved in Dual Connectivity according to prior art;

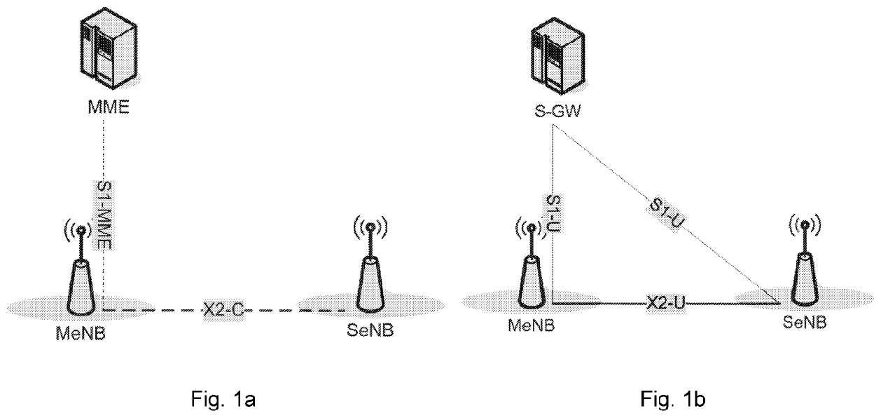

FIGS. 2a-2b show C-Plane and U-Plane connectivity of MR-DC with 5GC according to prior art;

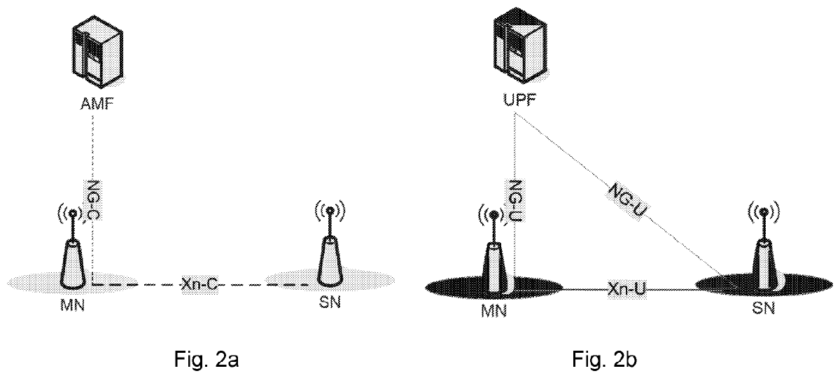

FIG. 3 shows network side protocol termination options for MCG, SCG and split bearers in MR-DC with EPC (EN-DC) according to prior art;

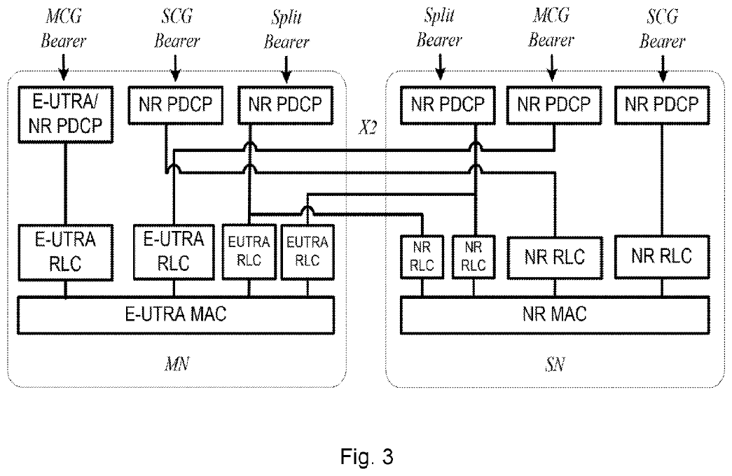

FIG. 4 shows Network side protocol termination options for MCG, SCG and split bearers in MR-DC with 5GC (NGEN-DC, NE-DC and NR-DC) according to prior art;

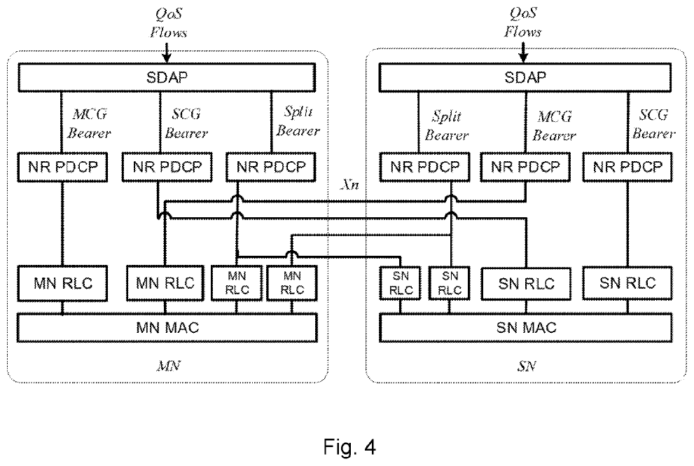

FIG. 5 shows PDCP Data PDU format for DRBs with 18 bits PDCP SN according to prior art;

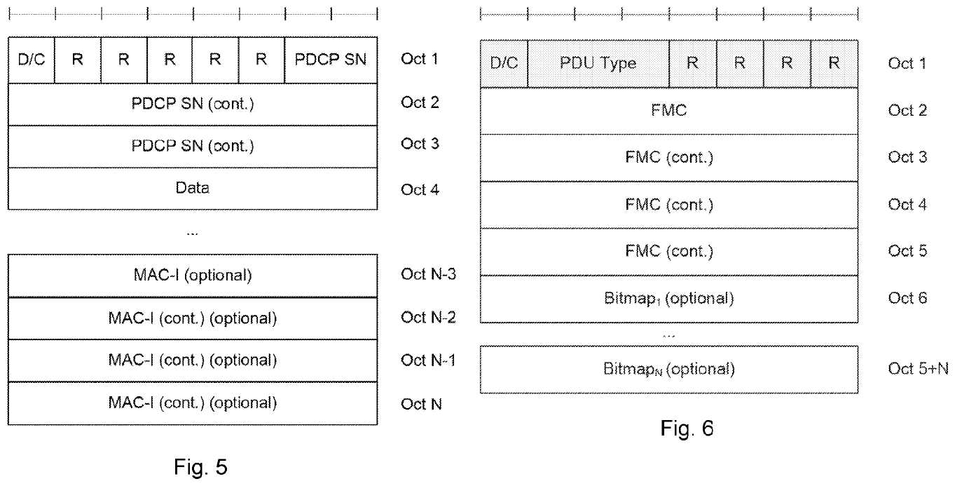

FIG. 6 shows a PDCP Control PDU format for PDCP status report according to prior art;

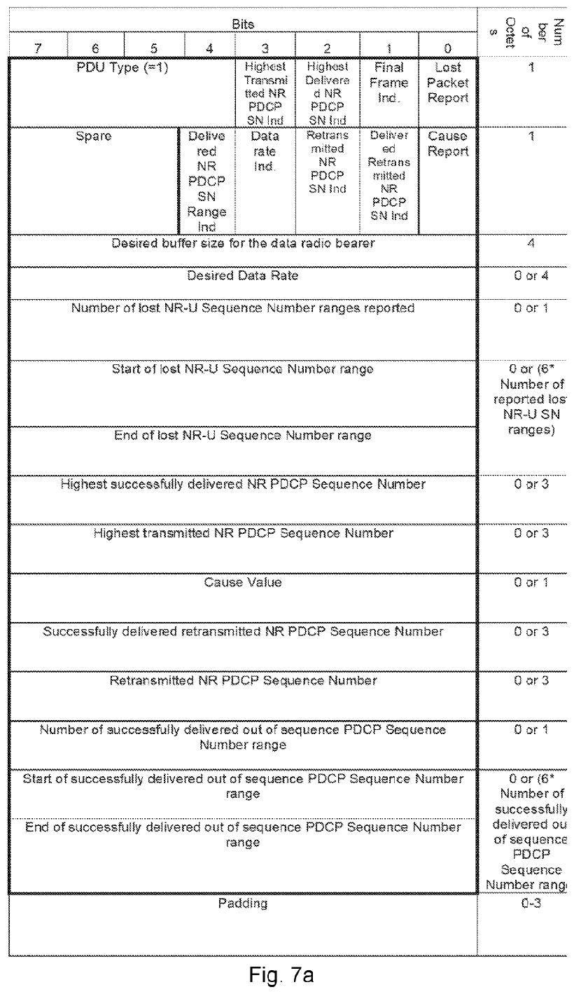

FIG. 7a shows a DL DATA DELIVERY STATUS (PDU Type 1) Format according to prior art;

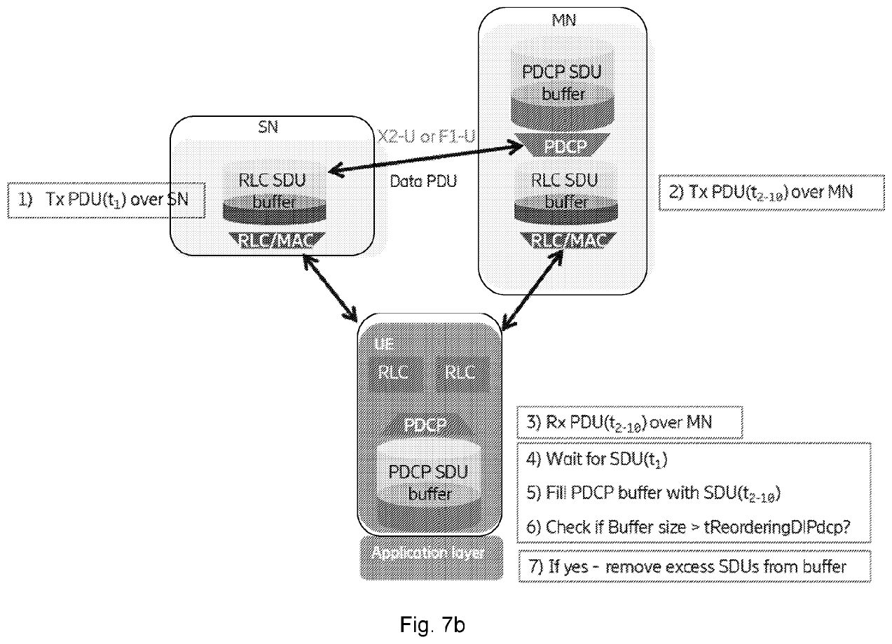

FIG. 7b shows an example of the flow control problem with a bad SN path according to prior art;

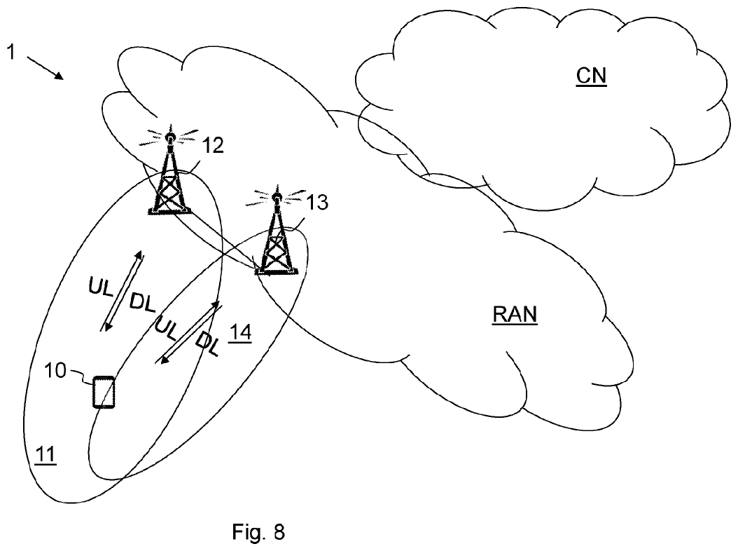

FIG. 8 shows a schematic overview depicting a wireless communication network according to embodiments herein;

FIG. 9 shows a combined flowchart and signalling scheme according to embodiments herein;

FIG. 10 shows a schematic flowchart depicting a method performed by a UE according to embodiments herein;

FIG. 11 shows a schematic flowchart depicting a method performed by a radio network node according to embodiments herein;

FIGS. 12a-12b show PDCP PDU formats according to embodiments herein;

FIG. 13 shows a block diagram depicting UEs according to embodiments herein;

FIG. 14 shows a block diagram depicting radio network nodes according to embodiments herein;

FIG. 15 schematically illustrates a telecommunication network connected via an intermediate network to a host computer;

FIG. 16 is a generalized block diagram of a host computer communicating via a base station with a user equipment over a partially wireless connection; and

FIGS. 17-20 are flowcharts illustrating methods implemented in a communication system including a host computer, a base station and a user equipment.

### DETAILED DESCRIPTION

Embodiments herein are described within the context of 3GPP NR radio technology. It is understood, that the problems and solutions described herein are equally applicable to wireless access networks and user equipments (UEs) implementing other access technologies and standards. NR is used as an example technology where embodiments are suitable, and using NR in the description therefore is particularly useful for understanding the problem and solutions solving the problem. In particular, embodiments are applicable also to 3GPP LTE, or 3GPP LTE and NR integration, also denoted as non-standalone NR.

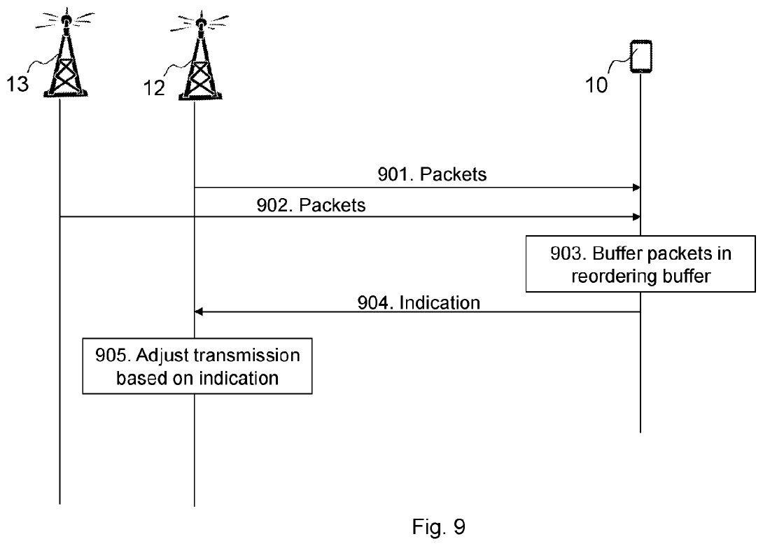

Embodiments herein relate to wireless communication networks in general. FIG. 8 is a schematic overview depicting a wireless communication network 1. The wireless communication network 1 comprises one or more RANs and one or more CNs. The wireless communication network 1 may use one or a number of different technologies, such as Wi-Fi, Long Term Evolution (LTE), LTE-Advanced, Fifth Generation (5G), Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context, however, embodiments are also applicable in further development of the existing wireless communication systems such as, e.g., WCDMA and LTE.

In the wireless communication network 1, wireless devices, e.g., a UE 10 such as a mobile station, a non-access point (non-AP) STA, a STA, a user equipment and/or a wireless terminal, communicate via one or more Access Networks (AN), e.g. RAN, to one or more core networks (CN). It should be understood by the skilled in the art that “UE” is a non-limiting term which means any terminal, wireless communication terminal, user equipment, Machine Type Communication (MTC) device, Device to Device (D2D) terminal, or node e.g. smart phone, laptop, mobile phone, sensor, relay, mobile tablets or even a small base station capable of communicating using radio communication with a network node within an area served by the network node.

The wireless communication network 1 comprises a first radio network node 12 providing radio coverage over a geographical area, a first service area 11, i.e., a first cell, of a radio access technology (RAT), such as 5G NR, LTE, Wi-Fi, WiMAX or similar. The first radio network node 12 may be a transmission and reception point e.g. a radio network node such as a Wireless Local Area Network (WLAN) access point or an Access Point Station (AP STA), an access node, an access controller, a base station, e.g. a radio base station such as a NodeB, an evolved Node B (eNB, eNode B), a gNodeB (gNB), a base transceiver station, a radio remote unit, an Access Point Base Station, a base station router, a transmission arrangement of a radio base station, a stand-alone access point or any other network unit or node capable of communicating with a UE within the area served by the first radio network node 12 depending e.g. on the radio access technology and terminology used. The first radio network node 12 may be referred to as the radio network node, master node (MN) or as a serving network node. The first radio network node 12 may provide the first cell which may be referred to as a serving cell or primary cell. The first radio network node 12 communicates with the UE 10, e.g. using the first cell, in form of DL transmissions to the UE 10 and UL transmissions from the UE 10.

The wireless communication network 1 comprises a second radio network node 13 providing radio coverage over a geographical area, a second service area 14, of a radio access technology (RAT), such as 5G NR, LTE, Wi-Fi, WiMAX or similar. The second radio network node 13 may be a transmission and reception point e.g. a radio network node such as a Wireless Local Area Network (WLAN) access point or an Access Point Station (AP STA), an access node, an access controller, a base station, e.g. a radio base station such as a NodeB, an evolved Node B (eNB, eNode B), a gNodeB (gNB), a base transceiver station, a radio remote unit, an Access Point Base Station, a base station router, a transmission arrangement of a radio base station, a stand-alone access point or any other network unit or node capable of communicating with a UE within the area served by the second radio network node 13 depending e.g. on the radio access technology and terminology used. The second radio network node 13 may be referred to as a secondary serving network node, secondary node (SN), or secondary network node, wherein the second service area may be referred to as a secondary serving cell or secondary cell, and the secondary serving network node communicates with the UE 10 in form of DL transmissions to the UE 10 and UL transmissions from the UE 10.

It should be noted that a service area may be denoted as cell, beam, beam group or similar to define an area of radio coverage.

Embodiments herein relate to transmission of data over a split bearer. The split bearer is operating between the first radio network node 12 and the UE 10, and between the second radio network node 13 and the UE 10. The UE 10 receives packets over the split bearer and puts the packets in a reordering buffer at the UE 10. The reordering buffer orders the packet so that the upper layer, such as application layers, receives the packets in order.

Embodiments herein allow a faster and more reliable way to update the network about the reordering buffer status by indicating, implicitly or explicitly, the status of the reordering buffer. The UE 10 may transmit one or more indications such as an indication of usage or level of the reordering buffer via the PDCP PDU header. Also, when or if there is a need for a very detailed reordering buffer status report from the UE 10, it is herein disclosed how this can be triggered and sent via a radio resource control (RRC) message, e.g., in the UEAssistanceInformation. The radio network node 12 may then take this indication into account when retransmitting packets or transmitting other packets.

Aspects described herein are described using the NR-NR DC framework, but is equally applicable to LTE-DC, EN-DC, NE-DC; NGEN-DC and NE-DC as well as possible multi-connectivity options involving more than two paths.

Embodiments herein are described in terms of MN terminated split bearers transmitted via a MCG, i.e., the first radio network node 12, and a SCG, i.e., the second radio network node 13. However, the solutions are equally applicable in case of SN terminated split bearers transmitted via the MCG and SCG, or in case of more than two paths, an MN, SN1, SN2, etc. terminated bearer transmitted via any two or more paths.

The assumption here is that we assume that the UE 10 is configured to deliver the PDCP packets in-order. This is the typical case since most services requires this.

Embodiments herein may relate to any one or more of the following:
A radio network node such as a RAN node, which may be any of gNB, eNB, en-gNB, ng-eNB, gNB-CU, gNB-CU-CP, eNB-CU, eNB-CU-CP.
A UE such as a terminal equipment, which supports any of E-UTRAN, NR, MR-DC, e.g., such as EN-DC, NE-DC, NR-DC.

Note that in a general scenario the term “radio network node” may be substituted with “transmission point”. Distinction between the transmission points (TPs) may typically be based on cell specific reference signals or different synchronization signals transmitted. Several TPs may be logically connected to the same radio network node but if they are geographically separated, or are pointing in different propagation directions, the TPs may be subject to the same mobility issues as different radio network nodes. In subsequent sections, the terms “radio network node” and “TP” may be thought of as interchangeable.

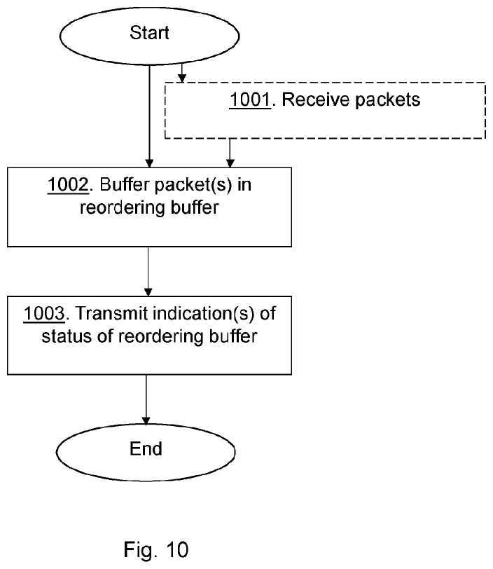

FIG. 9 is a combined flowchart and signalling scheme according to embodiments herein. The actions may be performed in any suitable order.

Action 901. The first radio network node 12 may transmit packets to the UE over the split bearer.

Action 902. The second radio network node 13 may transmit packets to the UE over the split bearer.

Action 903. The UE receives the packets and stores the respective packet in the reordering buffer. If the packet number matches the expected packet number of the next packet to deliver to higher layers, the UE delivers all consecutive stored packets in the reordering buffer in ascending order. In case the received packet number is larger than the expected packet number, the number of packets, i.e., the amount of data, in the reordering buffer increases.

Action 904. The UE 10 transmits to the first radio network node 12 and/or the second radio network node 13 one or more indications of the status of the reordering buffer. The indication may indicate a level of the reordering buffer. For example, the indication may indicate an amount of packets or data of respective transmission path to respective radio network node in the reordering buffer. For example, a ratio how many packets received from each path the reordering buffer contains.

Action 905. The first radio network node 12 may then adjust packet transmissions based on the receive indication. For example, the first radio network node 12 may select, for retransmitting a packet or an upcoming transmission, a transmission path of the split bearer that has a better performance than the other transmission path according to the received indication.

Thus, the solution allows a radio network node such as the first radio network node 12, to adjust the throughput of each transmission path via the indication or indications from the UE 10. The indication or indications, also referred to as the feedback, may indicate the received throughput from each transmission path or the ratio of how much data received from each transmission path the reordering buffer contains. This has the advantage that the radio network node can understand how the throughput changes per transmission path on a very early stage, e.g., before the UE 10 misses or throws away a packet.

The one or more indications may be included in a PDCP PDU header the UE 10 sends back to the first radio network node 12, or via any path. The one or more indications may be continuously transmitted, i.e., every PDCP PDU sent back to the first radio network node 12, or it can also be a single detailed feedback from the UE 10. The single detailed feedback: may indicate that a threshold of the reordering buffer is reached or has been exceeded; may comprise an indication that the threshold is reached and how much data is in the buffer; and/or may comprise an indication that the threshold is reached and which transmission path(s) the out-of-order packets were received from.

If the first radio network node 12 receives the one or more indications indicating that one of the transmission paths is causing the reordering buffer to be filled up, due too slow transmission or missing packets, the first radio network node 12 can pre-emptive any transmission path(s) and (re) send the PDCP packets from the transmission path causing the problem on the other transmission path.

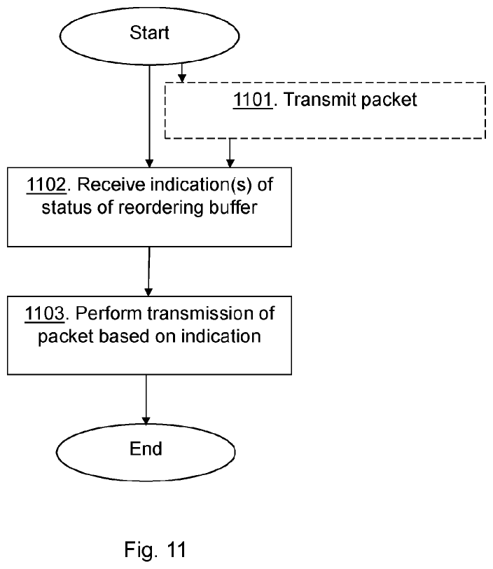

The method actions performed by the UE 10 for handling communication in the wireless communication network according to embodiments herein will now be described with reference to a flowchart depicted in FIG. 10. The actions do not have to be taken in the order stated below, but may be taken in any suitable order. Actions performed in some embodiments are marked with dashed boxes.

Action 1001. The UE 10 may receive packets over the split bearer between the first radio network node 12 and the UE 10, and between the second radio network node 13 and the UE 10. It should further be noted that the UE may receive configuration data for implementing embodiments herein. For example, the UE may receive a threshold level of the reordering buffer triggering the one or more indications sent.

Action 1002. The UE 10 buffers one or more packets from the first radio network node 12 and the second radio network node 13 received over the split bearer in the reordering buffer. It should here be noted that the UE 10 may receive packets from more than two radio network nodes, e.g., from one or more other secondary nodes being part of the split bearer.

Action 1003. The UE 10 then transmits one or more indications to one of the radio network nodes, wherein the one or more indications indicate the status of the reordering buffer. The one or more indications may comprise a level indication, wherein the level indication indicates that a level of the reordering buffer has reached the threshold level, or a level of the reordering buffer. For example, the threshold level may indicate an amount of data stored at the reordering buffer also referred to as a size of the buffer such as number of bits/bytes. And, thus, the level of the reordering buffer may mean the amount of data stored at the reordering buffer, such as number of bits/bytes, and may also be referred to as the size of the reordering buffer. The size may also be indicated by number of packets. The one or more indications may comprise an indication of which transmission path is causing an increase of level in the reordering buffer. Additionally, the one or more indications may comprise at least a one-bit value indicating presence of the one or more indications. Thus, the UE 10 may transmit two indications a first indication indicating presence of status of the reordering buffer and a second indication indicating the level or similar of the reordering buffer. The second indication may indicate an amount of data for the respective transmission path thus indicating which DRB and/or transmission path is causing the increase in the reordering buffer. The one or more indications may indicate a first throughput of a first transmission path of the split bearer and/or a second throughput of a second transmission path of the split bearer. The one or more indications may indicate throughput for the respective transmission path thus indicating which DRB and/or transmission path is causing the increase in the reordering buffer. For example, the one or more indications may comprise a link indication indicating a first performance of a first transmission path of the split bearer and/or a second performance of a second transmission path of the split bearer. The link indication may, for example, comprise a a ratio value, an amount of data, a number of packets and/or a throughput value, such as ratio the reordering buffer is filled with packets from the first transmission path relative packets from the second transmission path. Thus, the one or more indications may comprise a relative value indicating amount of data for the first transmission path in the reordering buffer relative amount of data of one or more other transmission paths. The one or more indications may be comprised in a PDCP header. The one or more indications may be comprised in a RRC message. For example, the one or more indications may be comprised in a hybrid automatic repeat request (HARQ) related message such as an acknowledgement (ACK) or a negative acknowledgement (NACK). The one or more indications may be transmitted according to a configured periodicity. The configured periodicity may be based on type of traffic, type of service and/or type of RAT.

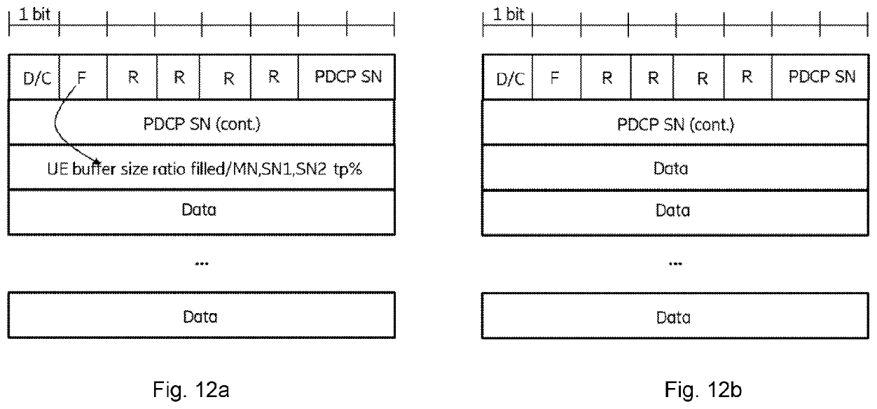

The method actions performed by the radio network node, such as the first radio network node 12 or the second radio network node 13, for handling transmission of data over the split bearer in the wireless communication network according to embodiments herein will now be described with reference to a flowchart depicted in FIG. 11. The actions do not have to be taken in the order stated below, but may be taken in any suitable order. Actions performed in some embodiments are marked with dashed boxes. The split bearer is arranged between the first radio network node 12 and the UE 10, and between the second radio network node 13 and the UE 10.

Action 1101. The radio network node may transmit packets over the split bearer to the UE 10. The radio network node may determine which transmission path should be used for each packet.

Action 1102. The radio network node receives the one or more indications from the UE 10, wherein the one or more indications indicate the status of the reordering buffer at the UE 10. The one or more indications may comprise the level indication, wherein the level indication indicates that the level of the reordering buffer has reached the threshold level, or the level of the reordering buffer. For example, the threshold level may indicate the amount of data stored at the reordering buffer also referred to as the size of the buffer such as number of bits/bytes. And, thus, the level of the reordering buffer may mean the amount of data stored at the reordering buffer, such as number of bits/bytes, and may also be referred to as the size of the reordering buffer. The one or more indications may comprise the indication of which transmission path is causing an increase of level in the reordering buffer. Additionally, the one or more indications may comprise the at least one-bit value indicating presence of the one or more indications. Thus, the radio network node may receive two indications, the first indication indicating presence of status of the reordering buffer and the second indication indicating the level or similar of the reordering buffer. The second indication may indicate the amount of data for the respective transmission path thus indicating which DRB and/or transmission path is causing the increase in the reordering buffer. The one or more indications may indicate first throughput of the first transmission path of the split bearer and/or the second throughput of the second transmission path of the split bearer. The one or more indications may be comprised in a PDCP header. The one or more indications may be comprised in a RRC message. For example, the one or more indications may be comprised in a HARQ related message such as an ACK or a NACK.

Action 1103. The radio network node performs the transmission of one or more packets over the split bearer based on the received one or more indications. For example, the radio network node may select a transmission path of the split bearer for an upcoming transmission or a retransmission of a packet based on the one or more indications. In some embodiments the one or more indications may comprise the link indication indicating the first performance of the first transmission path of the split bearer and/or the second performance of the second transmission path of the split bearer, wherein the radio network node performs the transmission by selecting the transmission path of the split bearer that has the better performance than the other transmission path according to the link indication. The link indication may comprise a ratio value, an amount of data, a number of packets and/or a throughput value, such as ratio the reordering buffer is filled with packets from the first transmission path relative packets from the second transmission path. Thus, the one or more indications may comprise the relative value indicating amount of data for the first transmission path in the reordering buffer relative amount of data of one or more other transmission paths.

Thus, embodiments herein solve the problem of the slow and inefficient flow control feedback.

When the UE 10 receives data, it needs to be processed in-order as missing data may corrupt the content. When the UE 10 receives data via a 3GPP technology, e.g., NR via the split bearer, the data received via either transmission path may be received out-of-order. This can also happen if there is packet loss on lower layers. The receiving PDCP layer stores any PDU received out-of-order and only forwards it to higher layers once all lower-numbered PDUs have been received and forwarded.

Since the radio network node typically implements a flow control, deciding which transmission path each data packet shall be sent over, if the instantaneous throughput of one of the transmission paths suddenly drops, some outstanding packets may get stuck on that transmission path, while the other transmission path continues to transmit data. This will lead to that the data gets stuck in the receiving PDCP layer, waiting to receive the outstanding packets from the malfunctioning transmission path.

Since the UE 10 is aware of the current throughput of a master and a secondary, and a possible tertiary, transmission path, as well as its current status of the reordering buffer, the UE 10 can detect that its own reordering buffer is being filled by packets from, e.g., the second (secondary) transmission path, while the UE 10 is waiting for packets from the master transmission path, or vice versa. Prior art has the disadvantage that a feedback is only triggered at certain occasions or events and then as a special message which makes it relatively inefficient.

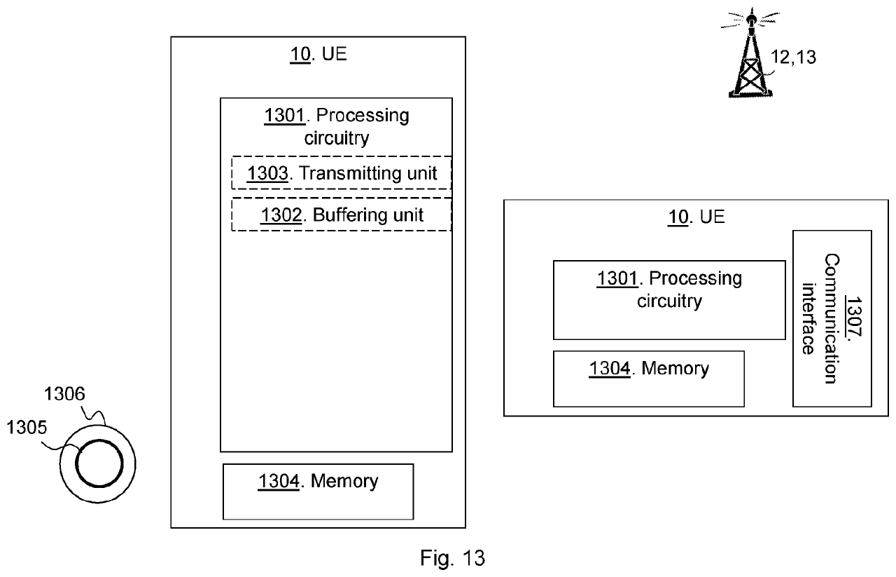

To overcome these problems and achieve a fast, continuous, and efficient feedback of the UE reordering buffer usage, one or more indications are added in, e.g., the header of the normal PDCP PDU in the opposite direction. All transmission control protocol (TCP) applications are two-way (both UL and DL) and there is at least one TCP ACK in the UL. The UE 10 may, thus inform the radio network node such as the first radio network node 12, continuously and efficiently that the reordering buffer is at risk of overflowing. Examples of a format of a new PDCP PDU are depicted in FIGS. 12a-12b. FIG. 12a shows the case where a special flag F indicates that there is one octet of further information of the UE reordering buffer usage. The FIG. 12b shows a simplest case where a flag “F” shows that the reordering buffer has exceed a certain threshold, i.e. the threshold level. The one or more indications may thus comprise:
a single indication that the reordering buffer has reached a predefined threshold, e.g., a level standardized, signaled via broadcasting or via dedicated signaling. The threshold may either be a fixed amount, e.g., x Mbits, or a ratio of the maximum size, e.g., y %;
a separate indication showing which transmission path is causing the overflow, e.g., reordering buffer is filled to x % with data from SCG or MCG.

An alternative is that the one or more indications may be sent via an RRC message, e.g. the UEAssistanceInformation with new fields or information elements (IE) for detailed buffer status usage.

Herein it is also disclosed how a detailed reordering buffer status usage and indication could be sent via the RRC message, e.g., the UEAssistanceInformation, see below. Relevant changes, relating to embodiments herein, are marked as bold and underlined.

### UEAssistanceInformation Message

-- ASN1START
-- TAG-UEASSISTANCEINFORMATION-START

| | |
|---|---|
| UEAssistanceInformation ::= | SEQUENCE { |
| criticalExtensions | CHOICE { |
| ueAssistanceInforamtion | UEAssistanceInformation-IEs, |
| criticalExtensionsFuture | SEQUENCE { } |

}
}

| | |
|---|---|
| UEAsistanceInforamtion-IEs ::= | SEQUENCE { |
| delayBudgetReport | DelayBudgetReport |

OPTIONAL,

| | |
|---|---|
| lateNonCriticalExtension | OCTET STRING |

OPTIONAL,

| | |
|---|---|
| nonCriticalExtension | UEAssistanceInformation-v1540-IEs |

OPTIONAL
}

| | |
|---|---|
| DelayBudgetReport::= | CHOICE { |
| type1 | ENUMERATED { |
| | msMinus1280, msMinus640, |

msMinus320, msMinus160,msMinus80, msMinus60, msMinus40,

msMinus20, ms0, ms20,ms40,

ms60, ms80, ms160, ms320, ms640, ms1280},
...
}
UEAssistanceInformation-v1540-IEs ::= SEQUENCE {

| | |
|---|---|
| overheatingAssistance | OverheatingAssistance |

OPTIONAL,

| | |
|---|---|
| nonCriticalExtension | UEAssistanceInformation-v1610-IEs |

OPTIONAL
}
UEAssistanceInformation-v1610-IEs ::= SEQUENCE {

| | |
|---|---|
| idc-Assistance-r16 | IDC-Assistance-r16 |

OPTIONAL,

| | |
|---|---|
| drx-Preference-r16 | DRX-Preference-r16 |

OPTIONAL,

| | |
|---|---|
| maxBW-Preference-r16 | MaxBW-Preference-r16 |

OPTIONAL,

| | |
|---|---|
| maxCC-Preference-r16 | MaxCC-Preference-r16 |

OPTIONAL,

| | |
|---|---|
| maxMIMO-LayerPreference-r16 | MaxMIMO-LayerPreference-r16 |

OPTIONAL,

| | |
|---|---|
| minSchedulingOffsetPreference-r16 | MinSchedulingOffsetPreference-r16 |

OPTIONAL,

| | |
|---|---|
| releasePreference-r16 | ReleasePreference-r16 |

OPTIONAL,

| | |
|---|---|
| sl-UE-AssistanceInformationNR-r16 | SL-UE-AssistanceInformationNR-r16 |

OPTIONAL,

| | |
|---|---|
| referenceTimeInfoPreference-r16 | BOOLEAN |

OPTIONAL,

| | |
|---|---|
| nonCriticalExtension | UEAssistanceInformation-vxxyy-IEs |

OPTIONAL
}
UEAssistanceInformation-vxxyy-IEs ::= SEQUENCE {

| | |
|---|---|
| reorderingBufferStatus | ReorderingBufferStatus |

OPTIONAL

| | |
|---|---|
| nonCriticalExtension | SEQUENCE { } |

OPTIONAL
}
ReorderingBufferStatus ::= SEQUENCE {

| | |
|---|---|
| reorderingBufferStatusList | ReorderingBufferStatusList |

OPTIONAL

| | |
|---|---|
| pathCausingBufferOverFlow | ENUMERATED {mcg, scg, spare2, spare1} |

OPTIONAL

| | |
|---|---|
| ratioOfReorderBufferFilled | ENUMERATED {0, 40, 50, 60, 70, 80, |

90, 100} OPTIONAL
}
ReorderingBufferStatusList ::= SEQUENCE (SIZE (1..maxDRB)) OF
ReorderingBufferStatusPerDRB
ReorderingBufferStatusPerDRB ::= SEQUENCE {

| | |
|---|---|
| drb-Identity | DRB-Identity, |
| pathCausingBufferOverFlow | ENUMERATED {mcg, scg, spare2, spare1} |

OPTIONAL
}

UEAssistanceInformation field descriptions

pathCausingBufferOverFlow
Indicates which path has delivered the most unacknowledged PDUs for the
DRB in the reordering buffer.
ratioOfReorderBufferFilled
Indicates how much of the reordering buffer is filled with data. 0
corresponds to below 40%, 40 corresponds to above 40%, 50 corresponds
to above 50% and so on.

It should be noted that the one or more indications from the UE 10 that the reordering buffer is too full may be sent as a Medium Access Control (MAC) Control Element (CE). This may be signalled similarly to a transmission buffer status report, i.e., an index showing how many bytes of data are currently in the reordering buffer. Alternatively, it could indicate that the level is above a certain threshold as well as indicate which DRB is causing the overflow.

As an example how this could work consider the following: The network, or the first radio network node 12, has set up a split bearer where the first radio network node 12, i.e., MCG, and the second network node 13, i.e., SCG, has equal throughput, i.e., the flow control splits the data 50/50 between the transmission paths. As the packets are being delivered, and the network received the ACKs for the packets, there will be a delay to receive the ACKs for the second radio network node 13 since these will have to be sent over the X2/Xn backhaul from the second radio network node 13 to the first radio network node 12.

However, according to embodiments herein, the one or more indications are sent continuously in the PDCP header such as an UL PDCP PDU header, and the first radio network node 12 may detect that one of the transmission paths are deteriorating fast and can take action to decrease, or even halt, the packet flow to that transmission path in time. If normal flow control would have been used, according to prior art, the network will continue to send packets to both paths and may continue until the network detects that there are too many outstanding packets on one path that are not acknowledged, e.g., from the RLC over the Xn/X2. Alternatively, the network may receive a PDU status report sent by the UE to the first radio network node 12 when enough PDU packets were missing. Embodiments herein achieve a fast, continuous, and efficient feedback from the UE 10 indicating reordering buffer status or usage.

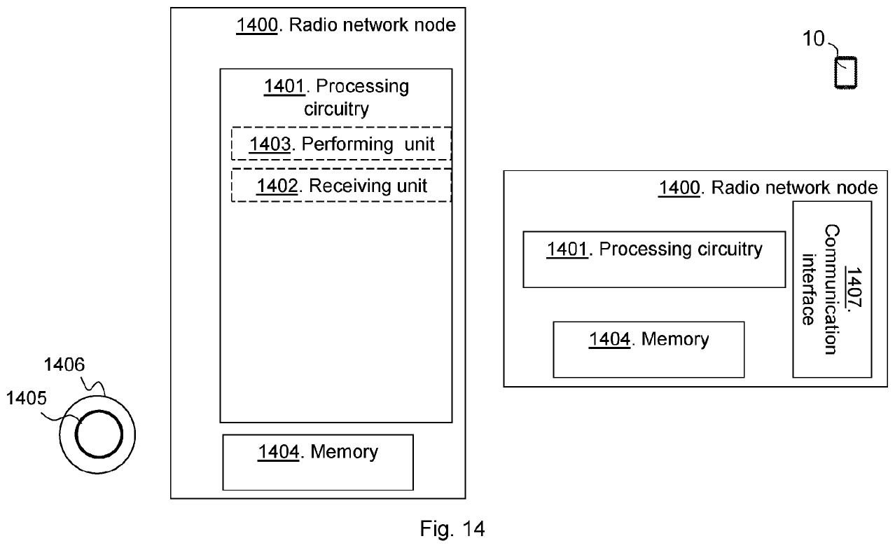

FIG. 13 is a block diagram depicting the UE 10, in two embodiments, for handling data transmitted over the split bearer between the first radio network node 12 and the UE 10, and between the second radio network node 13 and the UE 10 in the wireless communication network according to embodiments herein.

The UE 10 may comprise processing circuitry 1301, e.g., one or more processors, configured to perform the methods herein.

The UE may comprise a buffering unit 1302. The UE 10, the processing circuitry 1301, and/or the buffering unit 1302 is configured to buffer one or more packets from the first radio network node and the second radio network node received over the split bearer in the reordering buffer.

The UE may comprise a transmitting unit 1303, e.g., a transmitter or a transceiver. The UE 10, the processing circuitry 1301, and/or the transmitting unit 1303 is configured to transmit the one or more indications to one of the radio network nodes, e.g., the first or the second radio network node, wherein the one or more indications indicate the status of the reordering buffer, e.g., indicating usage of the reordering buffer. The one or more indications may comprise the level indication, wherein the level indication indicates that the level of the reordering buffer has reached the threshold level, or the actual level of the reordering buffer. The one or more indications may comprise an indication of which transmission path is causing an increase of level in the reordering buffer. The one or more indications may comprise at least a one-bit value indicating presence of the one or more indications. The one or more indications may indicate the first throughput of the first transmission path of the split bearer and/or the second throughput of the second transmission path of the split bearer. The one or more indications comprise the link indication indicating the first performance of the first transmission path of the split bearer and/or the second performance of the second transmission path of the split bearer. The link indication may comprise the ratio value, the amount of data, the number of packets, and/or the throughput value, such as the ratio the reordering buffer is filled with packets from the first transmission path relative packets from the second transmission path. Thus, the one or more indications may comprise a relative value indicating amount of data for the first transmission path in the reordering buffer relative amount of data of one or more other transmission paths. The one or more indications may be comprised in a PDCP header, also referred to as PDCP PDU header. The one or more indications may be comprised in an RRC message. The UE 10 may be configured to transmit the one or more indications according to a configured periodicity. The configured periodicity may be based on type of traffic, type of service and/or type of RAT.

The UE 10 further comprises a memory 1304. The memory comprises one or more units to be used to store data on, such as indications, thresholds, reordering buffer status, strengths or qualities, UL grants, requests, timers, applications to perform the methods disclosed herein when being executed, and similar. Thus, embodiments herein may disclose a UE for handling data transmitted over the split bearer between the first radio network node and the UE, and between the second radio network node and the UE in the wireless communication network, wherein the UE comprises processing circuitry and a memory, said memory comprising instructions executable by said processing circuitry whereby said UE 10 is operative to perform any of the methods herein. The UE 10 comprises a communication interface 1307 comprising, e.g., a transmitter, a receiver, a transceiver and/or one or more antennas.

The methods according to the embodiments described herein for the UE 10 are respectively implemented by means of, e.g., a computer program product 1305 or a computer program, comprising instructions, i.e., software code portions, which, when executed on at least one processor, cause the at least one processor to carry out the actions described herein, as performed by the UE 10. The computer program product 1305 may be stored on a computer-readable storage medium 1306, e.g., a universal serial bus (USB) stick, a disc or similar. The computer-readable storage medium 1306, having stored thereon the computer program product, may comprise the instructions which, when executed on at least one processor, cause the at least one processor to carry out the actions described herein, as performed by the UE 10. In some embodiments, the computer-readable storage medium may be a non-transitory or a transitory computer-readable storage medium.

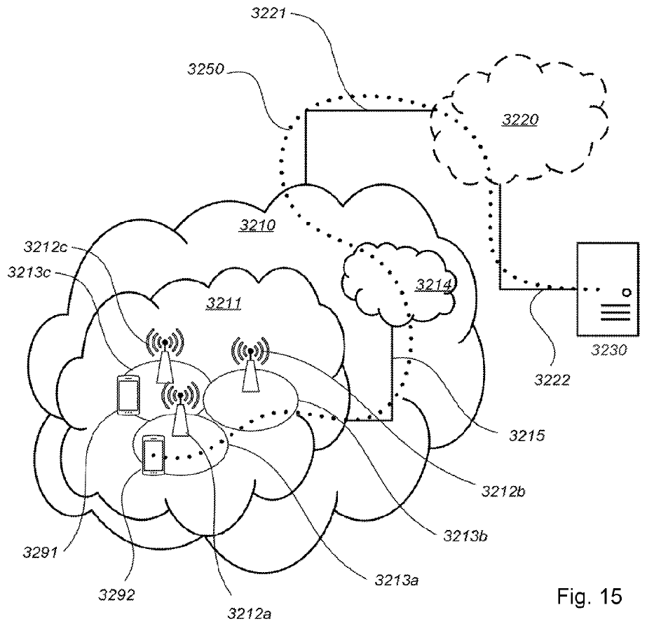

FIG. 14 is a block diagram depicting the radio network node 1400, in two embodiments, for handling transmission of data over the split bearer between the first radio network node 12 and the UE 10, and between the second radio network node 13 and the UE 10 in the wireless communication network 1 according to embodiments herein. The radio network node 1400 may be exemplified as the first radio network node 12 or the second radio network node 13.

The radio network node 1400 may comprise processing circuitry 1401, e.g. one or more processors, configured to perform the methods herein.

The radio network node 1400 may comprise a receiving unit 1402, e.g. a receiver and/or a transceiver. The radio network node 1400, the processing circuitry 1401, and/or the receiving unit 1402 is configured to receive the one or more indications from the UE 10, wherein the one or more indications indicate the status of the reordering buffer at the UE 10. The one or more indications may comprise the level indication, wherein the level indication indicates that the level of the reordering buffer has reached the threshold level, or the level of the reordering buffer. The one or more indications may comprise the indication of which transmission path is causing the increase of level in the reordering buffer. The one or more indications may comprise the one-bit value indicating presence of the one or more indications. The one or more indications may indicate the first throughput of the first transmission path of the split bearer and/or the second throughput of the second transmission path of the split bearer. The one or more indications may be comprised in a PDCP header. The one or more indications may be comprised in an RRC message.

The radio network node 1400 may comprise a performing unit 1403, e.g. a transmitter and/or a transceiver. The radio network node 1400, the processing circuitry 1401, and/or the performing unit 1403 is configured to perform the transmission of one or more packets over the split bearer based on the received one or more indications. The radio network node 1400, the processing circuitry 1401, and/or the performing unit 1403 may be configured to perform the transmission by selecting the transmission path of the split bearer for the upcoming packet based on the one or more indications. The one or more indications may comprise the link indication indicating the first performance of the first transmission path of the split bearer and/or the second performance of the second transmission path of the split bearer, and wherein the radio network node 1400, the processing circuitry 1401, and/or the performing unit 1403 may be configured to perform the transmission by selecting the transmission path of the split bearer that has the better performance than the other transmission path according to the link indication. The link indication may comprise the ratio value, the amount of data, the number of packets and/or the throughput value, such as the ratio the reordering buffer is filled with packets from the first transmission path relative packets from the second transmission path. Thus, the one or more indications may comprise the relative value indicating amount of data for the first transmission path in the reordering buffer relative amount of data of one or more other transmission paths.

The radio network node 1400 further comprises a memory 1404. The memory comprises one or more units to be used to store data on, such as thresholds, measurements, split information, indications, strengths or qualities, grants, scheduling information, timers, applications to perform the methods disclosed herein when being executed, and similar. Thus, embodiments herein may disclose a radio network node 13 for handling transmission of data over the split bearer between the first radio network node and the UE, and between the second radio network node and the UE in the wireless communication network 1, wherein the radio network node comprises processing circuitry and a memory, said memory comprising instructions executable by said processing circuitry whereby said radio network node is operative to perform any of the methods herein. The radio network node 1400 comprises a communication interface 1407 comprising transmitter, receiver, transceiver and/or one or more antennas.

The methods according to the embodiments described herein for radio network node 1400 are respectively implemented by means of, e.g., a computer program product 1405 or a computer program product, comprising instructions, i.e., software code portions, which, when executed on at least one processor, cause the at least one processor to carry out the actions described herein, as performed by the radio network node 1400. The computer program product 1405 may be stored on a computer-readable storage medium 1406, e.g., a USB stick, a disc or similar. The computer-readable storage medium 1406, having stored thereon the computer program product, may comprise the instructions which, when executed on at least one processor, cause the at least one processor to carry out the actions described herein, as performed by the radio network node 1400. In some embodiments, the computer-readable storage medium may be a non-transitory or transitory computer-readable storage medium.

In some embodiments a more general term “radio network node” is used and it can correspond to any type of radio network node or any network node, which communicates with a wireless device and/or with another network node. Examples of network nodes are NodeB, Master eNB, Secondary eNB, a network node belonging to Master cell group (MCG) or Secondary Cell Group (SCG), base station (BS), multi-standard radio (MSR) radio node such as MSR BS, eNodeB, network controller, radio network controller (RNC), base station controller (BSC), relay, donor node controlling relay, base transceiver station (BTS), access point (AP), transmission points, transmission nodes, Remote Radio Unit (RRU), Remote Radio Head (RRH), nodes in distributed antenna system (DAS), core network node e.g. Mobility Switching Centre (MSC), Mobile Management Entity (MME) etc., Operation and Maintenance (O&M), Operation Support System (OSS), Self-Organizing Network (SON), positioning node e.g. Evolved Serving Mobile Location Centre (E-SMLC), Minimizing Drive Test (MDT) etc.

In some embodiments the non-limiting term wireless device or user equipment (UE) is used and it refers to any type of wireless device communicating with a network node and/or with another UE in a cellular or mobile communication system. Examples of UE are target device, device-to-device (D2D) UE, proximity capable UE (aka ProSe UE), machine type UE or UE capable of machine to machine (M2M) communication, PDA, PAD, Tablet, mobile terminals, smart phone, laptop embedded equipped (LEE), laptop mounted equipment (LME), USB dongles etc.

The embodiments are described for 5G. However the embodiments are applicable to any RAT or multi-RAT systems, where the UE receives and/or transmit signals (e.g. data) e.g. LTE, LTE FDD/TDD, WCDMA/HSPA, GSM/GERAN, Wi Fi, WLAN, CDMA2000 etc.

As will be readily understood by those familiar with communications design, that functions means or modules may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of communications devices will appreciate the cost, performance, and maintenance trade-offs inherent in these design choices.

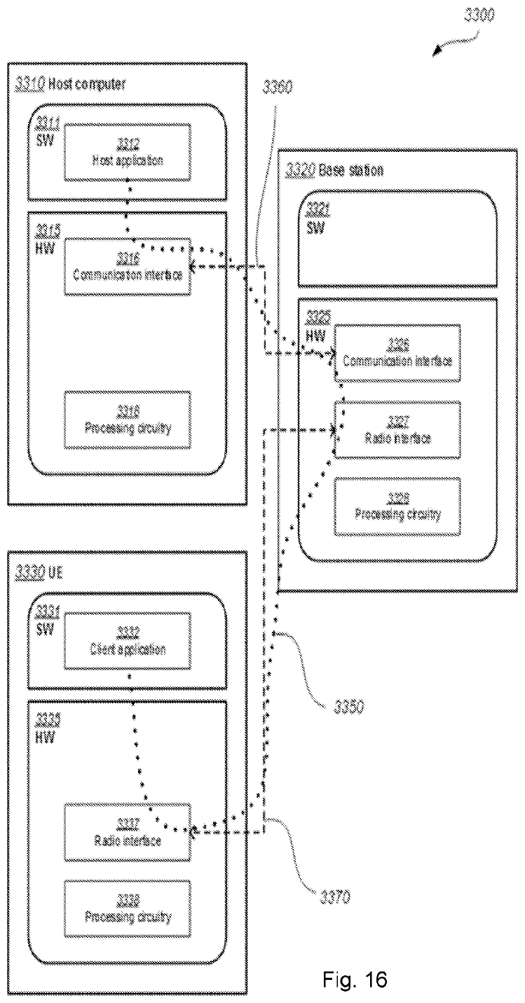

With reference to FIG. 15, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points being examples of the radio network node 12 herein, each defining a corresponding coverage area 3213a, 3213b, 3213c. Each base station 3212a, 3212b, 3212c is connectable to the core network 3214 over a wired or wireless connection 3215. A first user equipment (UE) 3291, being an example of the UE 10, located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 15 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

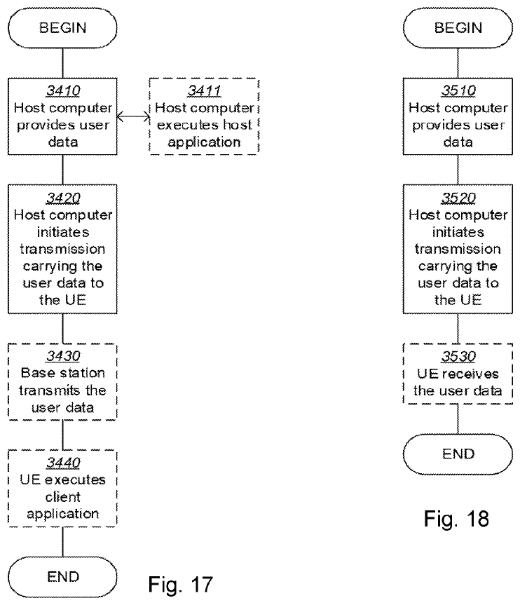

Example implementations, in accordance with an embodiment, of the UE, base station and host computer discussed in the preceding paragraphs will now be described with reference to FIG. 16. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 16) served by the base station 3320. The communication interface 3326 may be configured to facilitate a connection 3360 to the host computer 3310. The connection 3360 may be direct or it may pass through a core network (not shown in FIG. 16) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 16 may be identical to the host computer 3230, one of the base stations 3212a, 3212b, 3212c and one of the UEs 3291, 3292 of FIG. 15, respectively. This is to say, the inner workings of these entities may be as shown in FIG. 16 and independently, the surrounding network topology may be that of FIG. 15.

In FIG. 16, the OTT connection 3350 has been drawn abstractly to illustrate the communication between the host computer 3310 and the user equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the performance since transmission of data over the split beaerer is handled more efficiently and thereby provide benefits such as reduced user waiting time, and better responsiveness.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

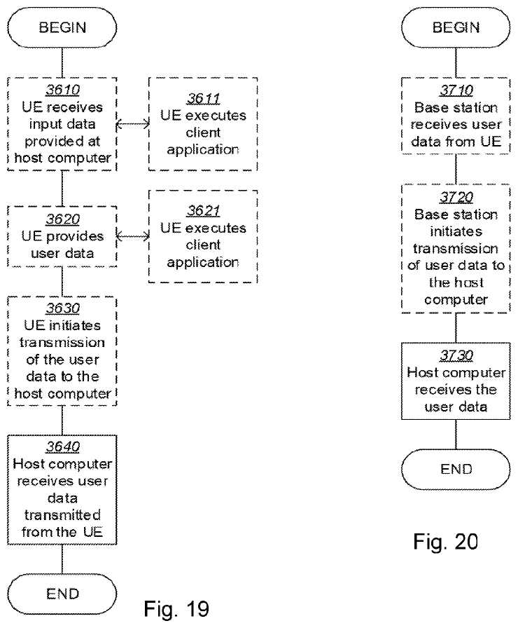

FIG. 17 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 17 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 18 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 18 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

FIG. 19 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 19 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 20 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 20 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

1. A method performed by a user equipment, UE, for handling data transmitted over a split bearer between a first radio network node and the UE, and between a second radio network node and the UE in a wireless communication network, the method comprising
buffering one or more packets from the first radio network node and the second radio network node received over the split bearer in a reordering buffer; and
transmitting one or more indications to one of the radio network nodes, wherein the one or more indications indicate a status of the reordering buffer.

2. The method according to claim 1, wherein the one or more indications comprise a level indication, wherein the level indication indicates that a level of the reordering buffer has reached a threshold level, or a level of the reordering buffer.

3. The method according to claim 1, wherein the one or more indications comprise an indication of which transmission path is causing an increase of level in the reordering buffer.

4. The method according to claim 1, wherein the one or more indications comprise at least a one-bit value indicating presence of the one or more indications.

5. The method according to claim 1, wherein the one or more indications indicates one or both of a first throughput of a first transmission path of the split bearer and a second throughput of a second transmission path of the split bearer.

6. The method according to claim 1, wherein the one or more indications comprise a link indication indicating one or both of a first performance of a first transmission path of the split bearer and a second performance of a second transmission path of the split bearer.

7. The method according to claim 6, wherein the link indication comprises one or more of a ratio value, an amount of data, a number of packets, and a throughput value.

8. The method according to claim 1, wherein the one or more indications is comprised in a packet data convergence protocol header.

9. The method according to claim 1, wherein the one or more indications is comprised in a radio resource control message.

10. The method according to claim 1, wherein the one or more indications is transmitted according to a configured periodicity.

11. The method according to claim 10, wherein the configured periodicity is based on one or more of type of traffic, type of service and type of radio access technology, RAT.

12. A method performed by a radio network node for handling transmission of data over a split bearer between a first radio network node and a user equipment, UE, and between a second radio network node and the UE in a wireless communication network, the method comprising
receiving one or more indications from the UE, wherein the one or more indications indicate a status of a reordering buffer at the UE; and
performing a transmission of one or more packets over the split bearer based on the received one or more indications.

13. The method according to claim 12, wherein performing the transmission comprises selecting a transmission path of the split bearer for an upcoming packet based on the one or more indications.

14. The method according to claim 12, wherein the one or more indications comprise a level indication, wherein the level indication indicates that a level of the reordering buffer has reached a threshold level, or a level of the reordering buffer.

15. The method according to claim 12, wherein the one or more indications comprise an indication of which transmission path is causing an increase of level in the reordering buffer.

16. The method according to claim 12, wherein the one or more indications comprise at least a one-bit value indicating presence of the one or more indications.

17. The method according to claim 12, wherein the one or more indications indicates one or both of a first throughput of a first transmission path of the split bearer and a second throughput of a second transmission path of the split bearer.

18. The method according to claim 12, wherein the one or more indications comprise a link indication indicating a first performance of a first transmission path of the split bearer and/or a second performance of a second transmission path of the split bearer, wherein performing the transmission comprises selecting a transmission path of the split bearer that has a better performance than the other transmission path according to the link indication.

19. The method according to claim 18, wherein the link indication comprises one or more of a ratio value, an amount of data, a number of packets and a throughput value.

20. The method according to claim 12, wherein the one or more indications is comprised in:
a packet data convergence protocol header; or
a radio resource control message.

21.-23. (canceled)

24. A user equipment, UE, for handling data transmitted over a split bearer between a first radio network node and the UE, and between a second radio network node and the UE in a wireless communication network, the UE is being configured to:
buffer one or more packets from the first radio network node and the second radio network node received over the split bearer in a reordering buffer; and
transmit one or more indications to one of the radio network nodes, wherein the one or more indications indicate a status of the reordering buffer.

25.-34. (canceled)

35. A radio network node for handling transmission of data over a split bearer between a first radio network node and a user equipment, UE, and between a second radio network node and the UE in a wireless communication network, the radio network node being configured to
receive one or more indications from the UE, wherein the one or more indications indicate a status of a reordering buffer at the UE; and
perform a transmission of one or more packets over the split bearer based on the received one or more indications.

36.-44. (canceled)
